(19) United States
(12) Patent Application Publication
(10) Pub. No.: US 2004/0170282 A1
(43) Pub. Date: Sep. 2, 2004

(54) Sound simulator and sound simulating method

(76) Inventors: Yasuhiko Tahara, Sendai-shi (JP); Shinichi Sasaki, Tokyo (JP); Katsuyuki Ishikawa, Tokyo (JP)

Correspondence Address: Frishauf Holtz, Goodman & Chick, 25th Floor, 767 Third Avenue, New York, NY, 10017, US

(21) Appl. No.: 10/483,924

(22) PCT Filed: Oct. 11, 2002
(86) PCT No.: PCT/JP02/10621

(30) Foreign Application Priority Data
Oct. 15, 2001 (JP) 2001-316273

(51) Int. Cl. H04R 25/00; H04R 29/00

(52) U.S. Cl. 381/58; 381/190; 381/111

(57) ABSTRACT

An acoustic simulation apparatus (10) comprises a model (12) having an acoustic space (11), a substantially nondirectional polyhedral loud speaker (20) provided with a plurality of piezoelectric loud speakers (22) and arranged at a prescribed position within the acoustic space (11), an amplifier (13a) for driving the plural piezoelectric loud speakers (22), a microphone (14a) for receiving a response acoustic signal generated in the acoustic space due to the driving of the loud speaker (20) in the acoustic space (11), a microphone amplifier (14b) for amplifying the output of the microphone (14a) to a prescribed amplitude, and a computer (17) for analyzing the output signal of the microphone amplifier (14b).

This application is a U.S. National Phase Application under 35 USC 371 of International Application PCT/JP02/10621 filed Oct. 11, 2002.

### TECHNICAL FIELD

The present invention relates to an acoustic simulation apparatus and an acoustic simulation method used for analysis of the acoustic characteristics of, for example, a concert hall.

### BACKGROUND ART

In the construction of a building having an acoustic space such as a concert hall, the acoustic characteristics of the acoustic space are simulated in the design stage in order to suppress to the minimum level the economical disadvantage that the modification of the building is rendered unavoidable because of, for example, the poor acoustic characteristics in the acoustic space after construction of the building. Also, such an acoustic simulation is utilized by contraries for designing the building having more excellent acoustic space.

As an acoustic simulation method, employed is a method in which a precise miniaturized building model is prepared, a sound source and a microphone are arranged at prescribed positions within the model, the acoustic signal generated from the sound source is collected by the microphone, and the obtained response acoustic signal is analyzed by a computer.

In general, the audible frequency band of the human being falls within a range of between about 20 Hz and 20 kHz. Since the acoustic characteristics in the frequency band of about 50 Hz to 10 kHz are particularly important in the concert hall, the acoustic simulation is performed with the particular frequency band used as a target. Also, in the acoustic simulation using the miniaturized building model, it is necessary to change the wavelength of the acoustic signal generated from the sound source in accordance with the degree of miniaturization of the building model. For example, in the acoustic simulation using a building model of 1/10 scale, it is necessary to decrease the wavelength of the acoustic signal generated from the sound source to 1/10. In other words, it is necessary to increase the frequency of the acoustic signal to 10 times as high as the frequency in the actual space. Such being the situation, in the acoustic simulation using a building model of, for example, 1/10 scale, required is a sound source capable of generating an acoustic signal having a frequency of about 500 Hz to 100 kHz. Further, it is necessary to miniaturize the sound source in accordance with the degree of miniaturization of the building model.

Under the circumstances, in the acoustic simulation using a building model, a pulse sound generated in the electric discharge by utilizing the discharge phenomenon is used as a point sound source.

However, the generation of the pulse sound by utilizing the discharge is carried out by applying a high voltage between a pair of electrodes disposed a prescribed distance apart from each other. As a result, the tip of the electrode is worn if the discharge is repeatedly carried out so as to be deformed. Also, the distance between the pair of the electrodes is changed by the wear of the electrodes. It follows that the pulse sound is changed so as to render poor the reproducibility of the pulse sound.

In order to carry out the acoustic simulation accurately, it is necessary to measure the same pulse sound as many times as possible and to calculate the average of the measured values. Such being the situation, if the reproducibility of the pulse sound is poor as pointed out above, a long time is required for measuring the pulse sound. Also, an additional problem is generated that a long time is required for the processing of the voluminous data on the measured pulse sound.

### DISCLOSURE OF THE INVENTION

An object of the present invention is to provide an acoustic simulation apparatus equipped with a sound source excellent in the output reproducibility and the controllability of the acoustic signal and an acoustic simulation method using the particular acoustic simulation apparatus.

According to a first aspect of the present invention, there is provided an acoustic simulation apparatus, comprising:

a model having a prescribed acoustic space;

a substantially nondirectional loud speaker having a piezoelectric acoustic element and arranged at a prescribed position within the acoustic space;

a driving device for driving the piezoelectric acoustic element in accordance with a prescribed driving signal;

a sound receiving device arranged at a prescribed position within the acoustic space for receiving a response acoustic signal generated in the acoustic space due to the driving of the piezoelectric acoustic element; and

a signal analyzing device for analyzing the response acoustic signal received by the sound receiving device.

According to a second aspect of the present invention, there is provided an acoustic simulation apparatus, comprising:

a model having a prescribed acoustic space;

a substantially nondirectional loud speaker arranged at a prescribed position within the acoustic space;

a driving device for driving the loud speaker in accordance with a prescribed driving signal;

a sound receiving device arranged at a prescribed position within the acoustic space for receiving a response acoustic signal generated in the acoustic space due to the driving of the loud speaker; and

a signal analyzing device for analyzing the response acoustic signal received by the sound receiving device,

wherein the loud speaker includes a polyhedric cabinet and a plurality of piezoelectric acoustic elements mounted on prescribed faces of the polyhedric cabinet.

According to a third aspect of the present invention, there is provided an acoustic simulation method using the acoustic simulation apparatus of the present invention defined above.

To be more specific, according to a third aspect of the present invention, there is provided an acoustic simulation method for analyzing the acoustic characteristics of the acoustic space, comprising steps of:

preparing a model having a prescribed acoustic space;

arranging a substantially nondirectional loud speaker having a plurality of piezoelectric acoustic elements at a prescribed position within the acoustic space;

arranging a sound receiving device for receiving a response acoustic signal generated in the acoustic space due to the driving of the substantially nondirectional loud speaker at a prescribed sound receiving point within the acoustic space; and

analyzing by using a signal analyzing device the response acoustic signal received by the sound receiving device when the plural piezoelectric acoustic elements are driven by a prescribed driving signal.

In the present invention, the acoustic signal is generated by driving the piezoelectric acoustic elements in accordance with a prescribed driving signal, with the result that the reproducibility and the controllability of the acoustic signal are satisfactory. It follows that the collection and analysis of the data used for the acoustic simulation can be performed efficiently and accurately.

A piezoelectric loud speaker, which is prepared by housing in a case having a sound releasing port a vibrating plate consisting of a piezoelectric ceramic thin plate and a reinforcing plate such as a metal foil attached to the piezoelectric ceramic thin plate, is suitably as the piezoelectric acoustic element. Also, in order that a plurality of piezoelectric acoustic elements are simultaneously driven in the same phase, some or all the plural piezoelectric acoustic elements are electrically connected in parallel, and a class-D amplifier is suitably used as the driving device. A time stretched pulse is used suitably as a driving signal for driving the piezoelectric acoustic element. By using the time stretched pulse, it is possible to collect efficiently the response acoustic signal in a wide frequency band.

In the conventional method of generating a pulse sound by utilizing the discharge phenomenon, the pulse sound is taken directly not only into the microphone but also into a microphone amplifier for amplifying the response acoustic signal collected by the microphone and into a cable for connecting the microphone to the microphone amplifier so as to generate a noise. Such being the situation, it was necessary to carry out a treatment for removing the noise from the obtained response acoustic signal. However, the discharge phenomenon is not utilized in the acoustic simulation apparatus of the present invention, with the result that such a noise is not generated in the present invention. It follows that the data processing can be carried out efficiently in this respect, too.

### BRIEF DESCRIPTION OF THE DRAWINGS

FIG. 1 schematically shows the construction of an acoustic simulation apparatus according to one embodiment of the present invention;

FIG. 2 is an oblique view showing the construction of a loud speaker included in the acoustic simulation apparatus shown in FIG. 1;

FIG. 3 is a cross sectional view showing the construction of the piezoelectric loud speaker constituting the loud speaker shown in FIG. 2;

FIG. 4 is a circuit diagram exemplifying the construction of the circuit of an amplifier;

FIG. 5A is an oblique view showing the outer appearance of another polyhedric loud speaker used in an acoustic simulation apparatus; and

FIG. 5B is an oblique view showing the outer appearance of still another polyhedric loud speaker used in an acoustic simulation apparatus.

### BEST MODE FOR WORKING THE INVENTION

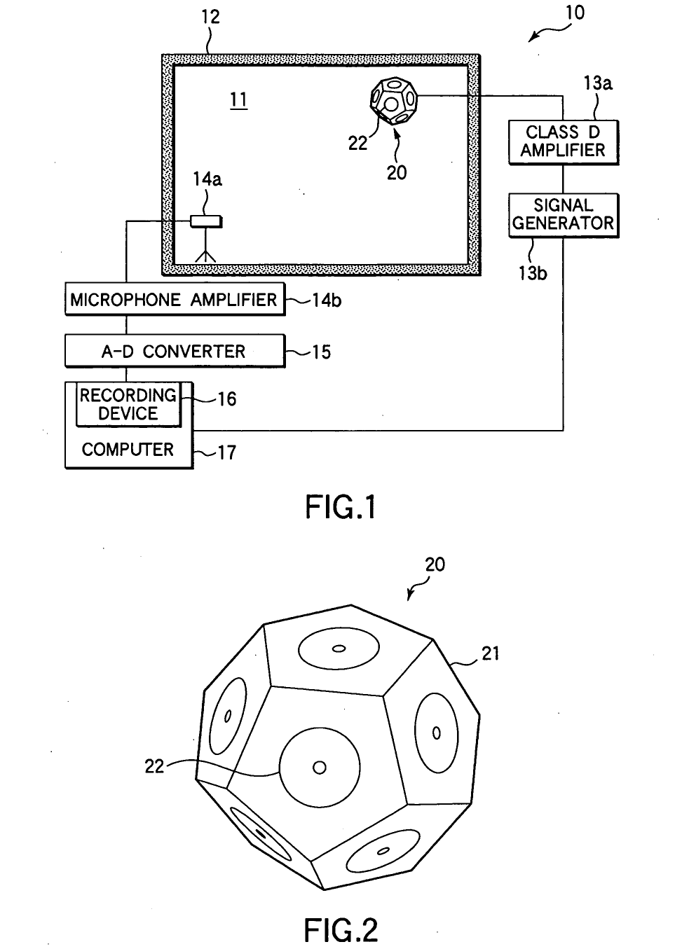

Some embodiments of the present invention in respect of the acoustic simulation apparatus and the acoustic simulation method will now be described with reference to the accompanying drawings. FIG. 1 schematically shows the construction of the acoustic simulation apparatus 10 according to one embodiment of the present invention, and FIG. 2 is an oblique view showing a loud speaker 20 included in the acoustic simulation apparatus 10 shown in FIG. 1.

The acoustic simulation apparatus 10 includes a model 12 having an acoustic space 11. Housed in the acoustic space 11 are a loud speaker 20 arranged at a prescribed position within the acoustic space 11, an amplifier (driving device) 13a for driving the loud speaker 20, a signal generator 13b for generating a prescribed signal (driving signal) that is to be supplied into the amplifier 13a, a microphone (sound receiving device) 14a arranged at a prescribed position within the acoustic space 11 for receiving a response acoustic signal in the acoustic space 11 based on the acoustic signal generated from the loud speaker 20, a microphone amplifier 14b for amplifying the output of the microphone 14a to a prescribed magnitude, an A-D converter 15 for converting the output signal of the microphone amplifier 14b into a digital signal, and a recording device 16 for recording the signal data digitized by the A-D converter 15. The acoustic simulation apparatus 10 also comprises a computer (signal analyzing device) 17 for analyzing the signal data recorded in the recording device 16.

Incidentally, the computer 17 is also used for preparation of the signal generated from the signal generator 13b and for controlling the entire acoustic simulation apparatus 10.

The model 12 having the acoustic space 11 is prepared by precisely reproducing the actual building such as a concert hall or a theater in a scale of about 1/10. The scaling degree is dependent on the upper limit of the frequency of the sound (acoustic signal) that can be generated from the loud speaker 20, as described herein later. It is desirable for the model 12 to be arranged within a soundless room in order to prevent a noise from entering the acoustic space 11.

The loud speaker 20 comprises a regular dodecahedral cabinet 21 and piezoelectric loud speakers (piezoelectric acoustic elements) 22 each mounted to the face of the dodecahedral cabinet 21.

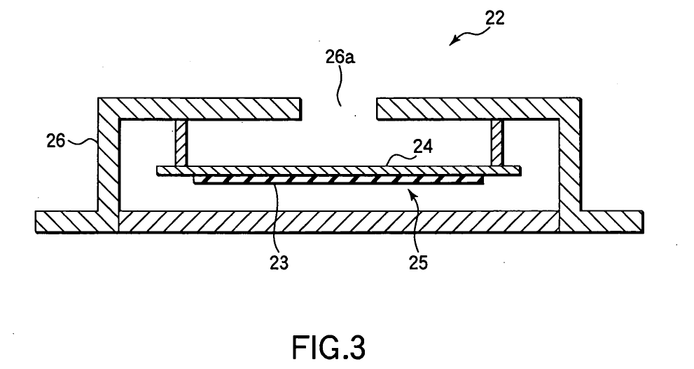

FIG. 3 is a cross sectional view showing the construction of the piezoelectric loud speaker 22 according to one embodiment of the present invention. As shown in the drawing, the piezoelectric loud speaker 22 is constructed such that a vibrating plate 25 is held within a case 26. The vibrating plate 25 is prepared by pasting a piezoelectric ceramic thin plate 23 to a reinforcing plate 24 such as a metal foil (metal plate) having a prescribed thickness by using an adhesive.

It is possible for the cabinet 21 to be formed of, for example, wood, a plastic material, a ceramic material, FRP or a metal sheet covered with an insulating coating as required. The cabinet 21 can be obtained by, for example, joining with an adhesive or the like the side surfaces of a plurality of plate-like members each forming a face of the regular dodecahedron or the side surfaces of several members having a plurality of faces formed integrally with each other. Alternatively, the cabinet 21 can be obtained by mounting plate-like members each forming a face of the regular dodecahedron to a frame forming the edges of the regular dodecahedron by using an adhesive or screws.

A disk-shaped member formed of a lead titanate zirconate system material is generally used as the piezoelectric ceramic thin plate 23, though the shape of the piezoelectric ceramic thin plate 23 is not particularly limited. Also, a copper foil, a phosphor bronze foil, a brazen foil, a stainless steel foil or a sheet prepared by attaching a metal sheet to a resin sheet is generally used as the reinforcing plate 24.

The piezoelectric ceramic thin plate 23 is polarized in the thickness direction, and electrode films (not shown) are formed on the front and back surfaces of the piezoelectric ceramic thin plate 23. If a prescribed AC voltage is applied to these electrode films, the vibrating plate 25 is vibrated because of the d₃₁ effect of the piezoelectric ceramic thin plate 23 so as to generate a sound (acoustic signal).

The sound thus generated is released to the outside through a sound releasing port 26a formed in the case 26. The acoustic signal generated from a single piezoelectric loud speaker 22 has a directivity that the acoustic signal is propagated in a prescribed direction. However, where the piezoelectric loud speaker 22 is mounted to each face of the regular dodecahedral cabinet 21, the entire acoustic signal generated from the loud speaker 20, i.e., the sound that is generated when the loud speaker 20 is operated is propagated substantially nondirectionally.

As pointed out above, the sound generated from the loud speaker 20 is propagated substantially nondirectionally. This indicates the state that a sound is generated from the loud speaker 20 such that the sound heard directly from the loud speaker 20 is recognized as the same sound by the human auditory sense on any site on a sphere having a prescribed radius as measured from the loud speaker 20. In other words, the loud speaker 20 can be regarded as a point sound source.

The piezoelectric loud speaker 22 can be driven over a wide frequency band ranging between a low frequency and a high frequency of, for example, 100 kHz. Therefore, it is possible to reduce the model 12 to 1/10 of the actual building or the like. Also, since the piezoelectric loud speaker 22 can be made thinner and miniaturized easily as shown in FIG. 3, it is possible to miniaturize the loud speaker 20 so as to make the loud speaker 20 closer to the type that is more preferable as a point sound source. Further, since the loud speaker 20 is caused to generate a prescribed acoustic signal by the driving of the piezoelectric loud speaker 22, the loud speaker 20 is excellent in the reproducibility and the controllability of the output of the acoustic signal.

Incidentally, it is certainly possible to form the regular dodecahedral loud speaker by using a vibrator including a magnet such as a known cone-shaped woofer or a dome-shaped tweeter. However, the vibrator using such a magnet is incapable of a high frequency driving, for example, 100 kHz. Therefore, it is necessary to determine the scaling degree of the model in accordance with the upper limit of the frequency of the acoustic signal that can be generated from the loud speaker. Such being the situation, it is difficult to miniaturize the model. Where it is impossible to miniaturize the model, a serious problem is generated that the manufacturing cost of the model is increased. Also, if the dodecahedral loud speaker is to be miniaturized, the magnets are concentrated on the inside of the loud speaker so as to give rise to the problem that an interference of the magnets is brought about so as to make it impossible to drive the vibrator. It follows that it is difficult to miniaturize the loud speaker itself so as to give rise to the necessity for enlarging the model. It is possible to avoid the particular problem if the piezoelectric loud speaker 22 is used for forming the loud speaker 20.

In order to allow the loud speaker 20 to generate an acoustic signal substantially nondirectionally, it is necessary to connect 12 piezoelectric loud speakers 22 in parallel and to drive these piezoelectric loud speakers 22 simultaneously at the same phase. Since each of the piezoelectric ceramic thin plate 23 has a large capacitance C, the entire resistance is lowered if 12 piezoelectric loud speakers 22 are connected in parallel. It follows that it is difficult to employ the technique of the class A amplification or the class B amplification. Under the circumstances, an amplifier (class D amplifier) for performing the class D amplification is suitably used as the amplifier 13a.

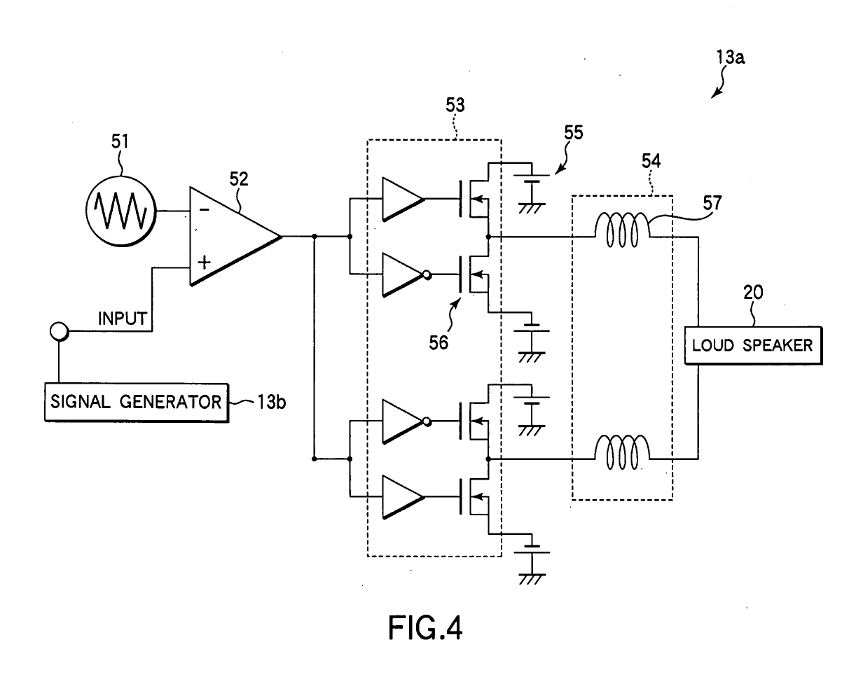

FIG. 4 is a circuit diagram exemplifying the circuit construction of the amplifier 13a. As shown in the drawing, the amplifier 13a comprises a triangular wave generator 51, a comparator 52, a switching circuit 53, and a rectifying circuit 54.

The data denoting the wave form of the signal supplied into the amplifier 13a can be prepared in the computer 17, and the data prepared in the computer 17 is supplied into the signal generator 13b so as to permit the signal generator 13b to generate a prescribed signal.

In the amplifier 13a, the input signal generated from the signal generator 13b is compared with a triangular wave generated in the triangular wave generator 51 in the comparator 52 so as to be converted into a digital signal, e.g., a PWM (pulse width modulation) signal. In the switching circuit 53, a switch 56, e.g., a power MOS FET, connected between a power source 55 and the loud speaker 20 is turned ON/OFF by the PWM signal. In this switching stage, the voltage of the PWM signal is amplified depending on the voltage value of the power source 55. The PWM signal having the voltage amplified as above is allowed to pass through a low pass filter (LPF) 57 included in the rectifying circuit 54 so as to be demodulated into the original input signal. In this fashion, the input signal is amplified to have a prescribed voltage and, then, supplied simultaneously into the twelve piezoelectric loud speakers 22 formed in the loud speaker 20.

Since the 12 piezoelectric loud speakers 22 are driven simultaneously, the acoustic signal generated from the loud speaker 20 is released into the acoustic space 11 substantially nondirectionally, and the response acoustic signal thereof is received by the microphone 14a.

Needless to say, the response acoustic signal received by the microphone 14a includes the sound generated directly from the loud speaker 20 in addition to the reflected sound (a primary reflected sound and a multi-order reflection sound) reflected from the wall and the floor forming the acoustic space 11.

The response acoustic signal generated from the loud speaker 20, received by the microphone 14a and amplified by the microphone amplifier 14b is an analog signal. Therefore, the analog signal is sampled at a prescribed frequency, e.g., 200 kHz, in the A-D converter 15 so as to be converted into a digital signal. Then, the digital signal thus formed is recorded in the recording device 16 such as a CD-R or a hard disk, which is mounted in the computer 17.

An impulse response of the acoustic space 11 can be obtained by applying a prescribed signal processing, e.g., the deconvolution, to the digital signal recorded in the recording device 16 by using the computer 17, and various acoustic characteristics such as an echo time pattern, a sound pressure distribution and a reverberation time can be obtained from the impulse response.

In the acoustic simulation in the acoustic space 11, it is possible to change easily the arranged position of the loud speaker 20 and the arranged position of the microphone 14a. Therefore, the acoustic characteristics of the acoustic space 11 can be analyzed easily in the case of changing the sound source position and the sound collecting position.

The acoustic simulation of the acoustic space 11, which is carried out by using the loud speaker 20, is exactly equal to the analysis of the acoustic characteristics in the actual acoustic space that is carried out in the actually built concert hall or theater. In, for example, the actually built hall, a regular dodecahedral dynamic loud speaker having a diameter of about 40 cm is driven by a prescribed signal including a signal having a frequency of about 50 Hz to 10 kHz, and the sound generated by the driving of the dynamic loud speaker is received by a microphone so as to analyze the received sound.

In other words, the acoustic simulation apparatus 10 of the present invention makes it possible to apply the analytical technology of the acoustic characteristics carried out in the actual building to the acoustic simulation of the acoustic space 11 of the model 12.

Known methods such as a rectangular pulse method, a sweep pulse method, and an M-sequence correlation method can be employed as the analytical method of the acoustic characteristics of the actual acoustic space. In the acoustic simulation apparatus 10, the acoustic simulation of the acoustic space 11 can be performed efficiently by employing, particularly, the sweep pulse method.

In the sweep pulse method, a time stretched pulse (TSP) containing all the frequencies falling within a range of, for example, between 500 Hz and 100 kHz is generated in the signal generator 13b, and the TSP thus generated is supplied into the amplifier 13a for amplification of the TSP. The piezoelectric loud speaker 22 is driven by the amplified signal so as to cause the loud speaker 20 to generate a prescribed sound. The sound generated within the acoustic space 11, which contains various information items, is received by the microphone 14a, and a processing called a reverse beating is carried out by using the computer 17 so as to obtain an impulse response.

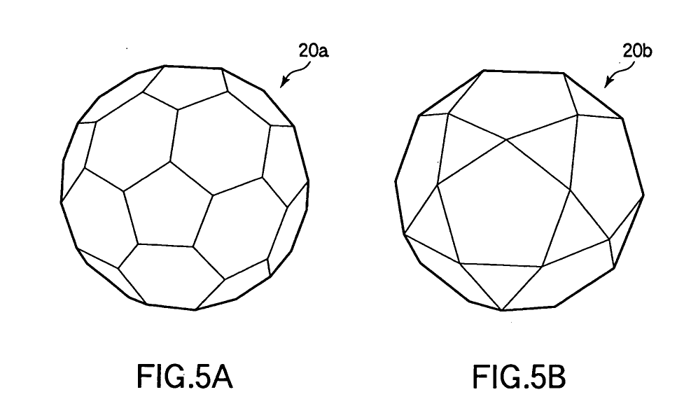

The present invention is not limited to the embodiment described above. For example, the loud speaker 20 is not limited to the regular dodecahedral loud speaker. It is possible for the loud speaker 20 to be formed of a polyhedral body of another shape as far as the acoustic signal can be propagated substantially nondirectionally. For example, it is possible for the loud speaker 20 to be formed of a polyhedral body 20a shown in FIG. 5A or to be formed of another polyhedral body 20b shown in FIG. 5B. Where the cabinet is shaped like the polyhedral body 20a shown in FIG. 5A, it is possible to mount the piezoelectric loud speakers to only the regular hexagonal faces. Also, it is possible for the piezoelectric loud speaker mounted to the hexagonal face to differ in size from the piezoelectric loud speaker mounted to the pentagonal face.

Further, it is possible for the loud speaker 20 to be formed of a polyhedral body having fewer faces than a regular dodecahedron, for example, a regular hexahedron, other than a polyhedral body having more faces than the regular dodecahedron, as shown in FIGS. 5A and 5B. Furthermore, it is possible to manufacture a substantially spherical nondirectional loud speaker by using a hemispherical piezoelectric ceramic body having a prescribed thickness as a vibrator and to use the substantially spherical nondirectional loud speaker thus manufactured as a sound source. In other words, the shape of the loud speaker 20 is not limited to a polyhedron.

In the embodiment described above, the piezoelectric loud speaker 22 having the vibrating plate 25 housed in the case 26 was mounted to the cabinet 21 so as to obtain the loud speaker 20. However, it is also possible to mount the vibrating plate 25 directly to each face of the cabinet 21. Also, it is possible to manufacture a polyhedral loud speaker by allowing the outer face of the piezoelectric loud speaker 22 (outer frame shape) to have, for example, a regular pentagonal shape, a regular hexagonal shape or a regular triangular shape and by bonding these faces of the piezoelectric loud speaker 22 to each other. In this case, it is possible to obtain a polyhedral loud speaker by using the piezoelectric loud speakers 22 alone without using the cabinet 21.

All of the piezoelectric loud speakers 22 need not be connected in parallel. In order to control the impedance of the loud speaker 20, some of the piezoelectric loud speakers 22 are connected in series in some cases.

Further, the response acoustic signal received by the microphone 14a is an analog signal. Therefore, it is possible to record the response acoustic signal in the form of an analog signal and to transmit the response acoustic signal recorded in the form of an analog signal to the computer 17 through an interface for converting the analog signal into a digital signal at a prescribed frequency for the analysis of the response acoustic signal.

### APPLICABILITY IN THE INDUSTRY

As described above, in the present invention, it is possible to output a prescribed acoustic signal by driving a piezoelectric acoustic element. Therefore, the reproducibility and the controllability of the output of the acoustic signal are satisfactory, compared with the prior art in which a pulse sound is generated by utilizing a discharge phenomenon. In addition, it is unnecessary to take a measure against the electromagnetic wave noise in the present invention. As a result, the collection and analysis of the data used for the acoustic simulation can be carried out efficiently and accurately. Also, since the acoustic simulation can be carried out by using the acoustic simulation apparatus of the present invention in the design stage of the acoustic space, it is possible to change easily the design of the acoustic space and to improve easily the acoustic characteristics. It follows that it is possible to suppress the occurrence of an uneconomical situation that a modification for improving the acoustic characteristics is required after completion in the construction of the actual building. Further, it is possible to create easily a space and arrange easily the space to produce excellent acoustic characteristics.

What is claimed is:

1. An acoustic simulation apparatus, comprising:
a model having a prescribed acoustic space;
a substantially nondirectional loud speaker having a piezoelectric acoustic element and arranged at a prescribed position within the acoustic space;
a driving device for driving the piezoelectric acoustic element in accordance with a prescribed driving signal;
a sound receiving device arranged at a prescribed position within the acoustic space for receiving a response acoustic signal generated in the acoustic space due to the driving of the piezoelectric acoustic element; and
a signal analyzing device for analyzing the response acoustic signal received by the sound receiving device.

2. An acoustic simulation apparatus, comprising:
a model having a prescribed acoustic space;
a substantially nondirectional loud speaker arranged at a prescribed position within the acoustic space;
a driving device for driving the loud speaker in accordance with a prescribed driving signal;
a sound receiving device arranged at a prescribed position within the acoustic space for receiving a response acoustic signal generated in the acoustic space due to the driving of the loud speaker; and
a signal analyzing device for analyzing the response acoustic signal received by the sound receiving device,
wherein the loud speaker includes a polyhedric cabinet and a plurality of piezoelectric acoustic elements mounted on prescribed faces of the polyhedric cabinet.

3. The acoustic simulation apparatus according to claim 2, wherein some or all of the plural piezoelectric acoustic elements are electrically connected to each other in parallel.

4. The acoustic simulation apparatus according to claim 1, wherein the piezoelectric acoustic element comprises:
a piezoelectric ceramic thin plate;
a reinforcing plate attached to the piezoelectric ceramic thin plate; and
a case having the piezoelectric ceramic thin plate and the reinforcing plate housed therein and provided with a sound releasing port at a prescribed position.

5. The acoustic simulation apparatus according to claim 1, wherein the driving device is a class D amplifier.

6. The acoustic simulation apparatus according to claim 2, wherein the piezoelectric acoustic element comprises:
a piezoelectric ceramic thin plate;
a reinforcing plate attached to the piezoelectric ceramic thin plate; and
a case having the piezoelectric ceramic thin plate and the reinforcing plate housed therein and provided with a sound releasing port at a prescribed position.

7. The acoustic simulation apparatus according to claim 2, wherein the driving device is a class D amplifier.

8. An acoustic simulation method for analyzing the acoustic characteristics of the acoustic space, comprising the steps of:
preparing a model having a prescribed acoustic space;
arranging a substantially nondirectional loud speaker having a plurality of piezoelectric acoustic elements at a prescribed position within the acoustic space;
arranging a sound receiving device for receiving a response acoustic signal generated in the acoustic space due to the driving of the substantially nondirectional loud speaker at a prescribed sound receiving point within the acoustic space; and
analyzing by using a signal analyzing device the response acoustic signal received by the sound receiving device when the plural piezoelectric acoustic elements are driven by a prescribed driving signal.

9. The acoustic simulation method according to claim 8, wherein a time stretched pulse is used as the driving signal.
